(19) United States
(12) Patent Application Publication
(10) Pub. No.: US 2020/0057420 A1
(43) Pub. Date: Feb. 20, 2020

(54) I/O MODULE FOR USE IN AN AUTOMATION SYSTEM; A METHOD FOR CONFIGURATION AND/OR PARAMETERIZATION OF A CONTROL DEVICE AND A METHOD FOR CREATING A DIGITAL WIRING PROTOCOL FOR AN AUTOMATION SYSTEM

(71) Applicant: Phoenix Contact GmbH & Co. KG, Blomberg (DE)

(72) Inventor: Benjamin KLIMMEK, Aerzen (DE)

(21) Appl. No.: 16/487,672

(22) PCT Filed: Feb. 16, 2018
(86) PCT No.: PCT/EP2018/053932

§ 371 Date: Aug. 21, 2019

(30) Foreign Application Priority Data
Feb. 21, 2017 (DE) 10 2017 103 553.2

(51) Int. Cl. G05B 19/042; H04W 4/80

(52) U.S. Cl. CPC G05B 19/0425; H04W 4/80; G05B 19/0426

(57) ABSTRACT

An I/O module for use in an automation system, has at least one terminal connection point for connecting a signal line and at least one information carrier which contains configuration and/or parameterization information, wherein the information carrier is designed for output by means of a mobile and portable reading device.

### FIELD

The invention relates to an I/O module for use in particular in an industrial automation system, and to a method for configuration and/or parameterization of a control device of an automation system, and to a method for creating a digital wiring protocol for an automation system.

### BACKGROUND

Wiring, parameterization, and configuration of automation systems is time-consuming and labor-intensive. Components of the automation systems are frequently replaced or added, so that wiring, configuration, and parameterization changes.

From EP 3 012 698 A1, a system and a method is known for wireless configuration and/or parameterization of miniature control devices. A miniature or mini control device has a unique device identifier assigned thereto, which is stored in the miniature control device in a data memory and is attached to the miniature control device so as to be optically identifiable. The unique device identifier can be optically identified by a configuration and/or parameterization device and can be associated with configuration and/or parameterization data stored in the configuration and/or parameterization device, which can be transferred wirelessly to the miniature control device together with the identified device identifier.

### SUMMARY

The invention is based on the object to provide an I/O module for use in an automation system, a method for configuration and/or parameterization of a control device of an automation system, and a method for creating a digital wiring protocol for an automation system, which allow to faster and easier identify and make available configuration and/or parameterization data, in particular in order to be able to wire the components of an automation system more reliably.

This technical problem is solved, inter alia, by the features of claim 1.

Accordingly, an I/O module is provided for use in an automation system, which comprises at least one terminal connection point for connecting a signal line, and at least one information carrier which contains configuration and/or parameterization information. The information carrier is adapted for being read out, in particular in wireless manner, by means of a mobile and portable reading device.

In order to be able to assign configuration and/or parameterization information to the I/O module in a simple and flexible manner, the I/O module has a housing to which the information carrier can be attached, preferably releasably. The configuration and/or parameterization information is applied on the information carrier in the form of an opto-electronically readable code and can be read by a mobile and portable reading device that includes an optical sensor. Preferably, the code is a bar code or a QR code.

Alternatively, the information carrier can preferably be in the form of a digital memory of an NFC chip, and the configuration and/or parameterization information stored in the information carrier can be read out by means of a mobile and portable NFC-capable reading device. It should be noted that the acronym NFC stands for Near Field Communication.

Preferably, the I/O module has a plurality of terminal connection points, each one for connecting a respective signal line, wherein each terminal connection point has an information carrier assigned thereto, which carries respective configuration and/or parameterization information.

It should be noted at this point that the I/O module may, for example, be implemented as a bus terminal block in the form of a feed-through terminal having two terminal connection points, or in the form of a sensor or of an actuator.

The configuration and/or parameterization information may include addressing information of the I/O module, and/or terminal connection point identification information such as a terminal connection point number, labelling as a destination terminal connection point and/or labelling as a start terminal connection point, and/or a function specification, and/or a resource identifier, and/or information about a signal line to be connected to the I/O module, and/or information about a terminal connection point of a further I/O module. The information specifying a signal line to be connected may indicate, for example, the type of the line, the color of the line, the cross section of the line, or the length of a line.

The I/O module expediently has fastening means for being mounted on a mounting rail, in particular a hat rail, and/or fastening means for being mounted on a component that can be mounted on a mounting rail.

The technical problem stated above is also solved by the method steps of claim 9.

Accordingly, a method is provided for configuration and/or parameterization of a control device of an automation system which comprises at least one I/O module that is capable of communicating with the control device via a transfer medium, in particular a field bus. The method comprises the following steps:

a) reading out the configuration and/or parameterization information from at least one information carrier of the at least one I/O module by means of a mobile and portable reading device, wherein the configuration and/or parameterization information read out from the at least one information carrier contains addressing information of the I/O module;

b) reading the configuration and/or parameterization information stored in the reading device into a memory of the control device; and

c) transmitting addressing information from the control device to the at least one I/O module.

According to an advantageous embodiment, step a) comprises to read out the configuration and/or parameterization information from at least one information carrier of the at least one I/O module in wireless manner. At step b) the configuration and/or parameterization information stored in the reading device are read into the memory of the control device, in a wireless manner.

Usually, a plurality of I/O modules are implemented in an automation system. In this case, the method according to the invention is distinguished by a high efficiency, since the configuration and/or parameterization information of all connected I/O modules can be read easily by means of the reading device and can then, in a further step, be read into the memory of the control device in wireless manner.

The technical problem stated above is also solved by the method steps of claim 11.

Frequently, new I/O modules are added to or replaced in an existing automation system and new signal lines are connected.

In order to be able to log these measures simply and quickly, a method is provided for creating a digital wiring protocol for an automation system which comprises a plurality of I/O modules that are connected to a control device via a communication network.

Using a predetermined wiring list, predetermined terminal connection points of the I/O modules included in the automation system each have assigned thereto an information carrier which contains, as configuration and/or parameterization information, a first item of information identifying the respective I/O module, and/or a second item of information indicating a predetermined terminal connection point of the respective I/O module as a start or destination terminal connection point of a wiring, and/or a third item of information indicating a predetermined terminal connection point of a further I/O module as a destination or start terminal connection point of the respective wiring. The configuration and/or parameterization information is read from the information carriers by means of a mobile and portable reading device. Then, a digital wiring protocol for further use is created from the read configuration and/or parameterization information in the reading device or in a separate computer device.

### BRIEF DESCRIPTION OF THE DRAWINGS

The invention will now be explained in more detail with reference to some exemplary embodiments in conjunction with the accompanying drawings, wherein:

FIG. 1 shows an exemplary automation system with a control device and a plurality of I/O modules, in which the invention is implemented;

FIGS. 2a and 2b show an exemplary information carrier that is releasably attachable to an I/O module;

FIG. 3a shows an exemplary portable and mobile reading device with optical sensor;

FIG. 3b shows an exemplary portable and mobile NFC-capable reading device; and

FIG. 4 shows another exemplary automation system in which the invention is implemented.

### DETAILED DESCRIPTION

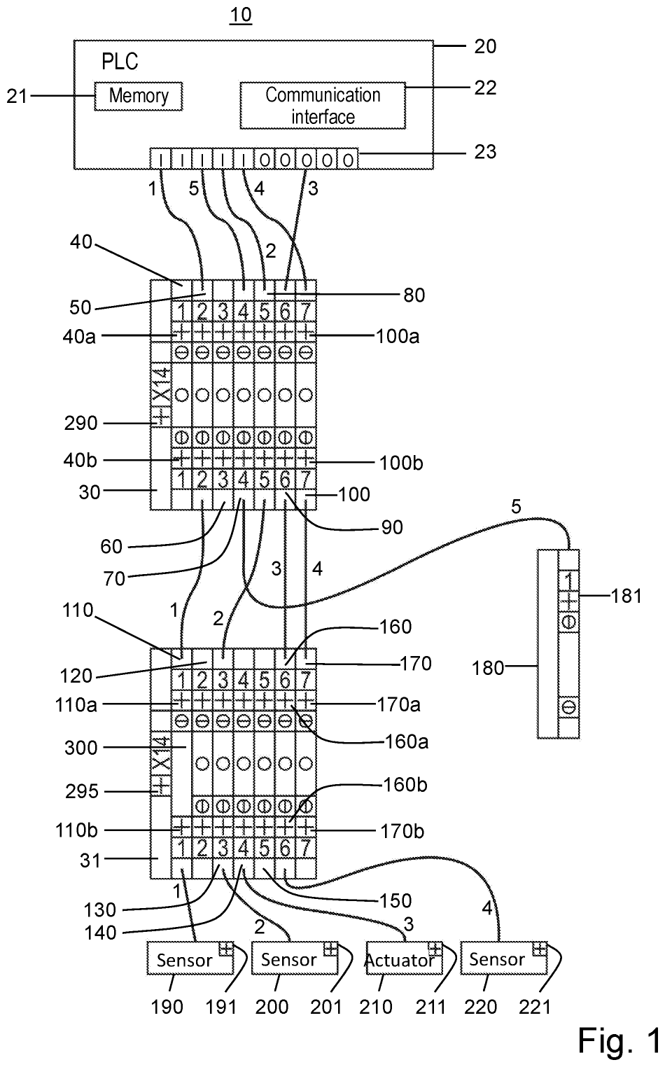

FIG. 1 shows a section of an exemplary automation system 10 which comprises a control device 20 that may be implemented as a PLC, that is a programmable logic controller.

Control device 20 comprises, inter alia, a memory device 21 which is able to store configuration and/or parameterization information of I/O modules. Furthermore, control device 20 includes a communication interface 22, via which it is able to communicate with a portable and mobile reading device 230 shown in FIG. 3a. Communication interface 22 may be an NFC-capable interface, or a USB interface, or a Bluetooth interface, for example. In this case, the reading device 230 will likewise have an NFC-capable interface, a USB interface, or a Bluetooth interface, for example.

Assuming, that the communication interface 22 is an NFC-capable communication interface, and that the reading device 230 also has an NFC-capable communication interface 233. In addition, the control device 20 comprises, in a manner known per se, a plurality of input and output interfaces 23 for direct or indirect connection of field devices such as sensors and actuators.

As shown in FIG. 1, the automation system 10 comprises, for example, an input/output assembly 30 comprising seven I/O modules 40 to 100 which are implemented as feed-through terminals. Each I/O module has two terminal connection points, each of which has an information carrier assigned thereto. The terminal connection points are marked by 1, 2, 3, 4, 5, 6, and 7, respectively. Each terminal connection point is intended for connecting a signal line. For the sake of simplicity of illustration, only the information carriers of I/O module 40 are designated by reference numerals 40a and 40b, and the information carriers of I/O module 100 by reference numerals 100a and 100b in FIG. 1. Additionally, the input/output assembly 30 may be equipped with an information carrier 290 that stores an identification information, for example.

As shown in FIG. 1, the automation system 10 may comprise a further input/output assembly 31, comprising seven I/O modules 110 to 170, for example, which, again, are implemented as feed-through terminals. Input/output assemblies 30 and 31 may be mounted on different mounting rails which may be arranged in a single switch cabinet or in different switch cabinets. Each I/O module has two terminal connection points, each of which has an information carrier assigned thereto. The terminal connection points are each marked by 1, 2, 3, 4, 5, 6, and 7, respectively. Each terminal connection point is intended for connecting a signal line. In FIG. 1, for the sake of simplicity of illustration, only the information carriers of I/O module 110 are designated by reference numerals 110a and 110b, the information carriers of I/O module 160 by reference numerals 160a and 160b, and the information carriers of I/O module 170 by reference numerals 170a and 170b. Additionally, the input/output unit 31 may be equipped with an information carrier 295 that stores an identification information, for example.

Each information carrier contains configuration and/or parameterization information which may include addressing information of the respective I/O module, and/or terminal connection point identification information, and/or a function specification, and/or a resource identifier, and/or information about a signal line to be connected to the I/O module, and/or information about a terminal connection point of a further I/O module. Terminal connection point identification information includes, for example, the number of the terminal connection point and optionally an indication of the respective terminal connection point as a destination terminal connection point or as a start terminal connection point. The information regarding a signal line to be connected may include the type of the line, the color of the line, the section cross of the line, and/or the length of the signal line to be connected.

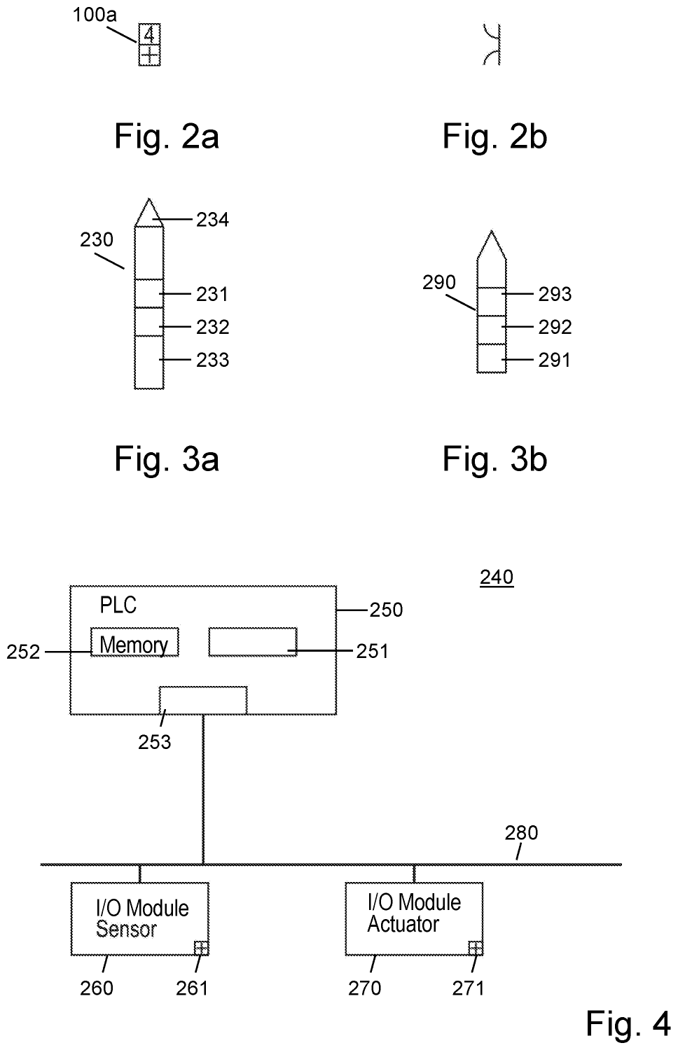

The information carriers 40a to 100b and 110a to 170b may, for example, comprise information carriers made of plastics, which can be releasably attached to a housing of the respective I/O modules 40 to 100 and 110 to 170. FIGS. 2a and 2b show the information carrier 100a, by way of example, with integrally formed fastening means for being releasably attached to I/O module 100. Information carrier 100a may include, for example, a terminal connection point numeral 7 and an opto-electronically readable code, such as a bar code or QR code storing the configuration and/or parameterization information.

The information carriers 40a to 100b and 110a to 170b which are releasably attachable to I/O modules 40 to 100 and 110 to 170 can be read out using the mobile and portable reading device 230. If, as mentioned, the information carriers carry a bar code or a QR code, for example, the mobile and portable reading device 230 includes an optical sensor 234 for reading out the information carriers. The read-out information can be stored in a memory 231.

Instead of assigning, to the terminal connection points, an information carrier that is releasably attachable to the housing of the I/O modules, each terminal connection point may have assigned thereto an information carrier that may be implemented as a memory of an NFC chip arranged in the respective I/O module. Then, each NFC chip stores the configuration and/or parameterization information of the respective I/O module or the respective terminal connection point. The configuration and/or parameterization information stored in each NFC chip can be read into the NFC chip and/or read out from the NFC chip by means of the mobile and portable reading device 230, for example. This means that in a design phase, the configuration and/or parameterization information of all I/O modules or all terminal connection points of the I/O modules can be written into the reading device 230 from a separate computer, for example.

Instead of configuring the input/output assemblies 30 and 31 from individual I/O modules each having two terminal connection points, it is conceivable to use a respective I/O module that comprises seven terminal pairs, for example.

I/O modules 40 to 170 may have fastening means (not shown) for being mounted on a mounting rail, in particular a hat rail. Additionally or alternatively, the I/O modules may include fastening means for being mounted to components that are mounted on a mounting rail.

The automation system 10 furthermore includes an I/O module 180 having a single terminal connection point 1 for connecting a signal line. The I/O module 180 may be configured as an actuator or a sensor. In the present example it is assumed that the I/O module 180 is a sensor. The single terminal connection point of sensor 180 has assigned thereto an information carrier 181 which may again be implemented as a releasably attachable information carrier on which an opto-electronically readable code is applied, which encodes configuration and/or parameterization information. Alternatively, the information carrier 181 may as well be implemented in the form of a memory of an NFC chip which stores the configuration and/or parameterization information.

For example, as shown in FIG. 1, three sensors 190, 200, and 220 and one actuator 210 may be connected to the control device 20 via the two input/output assemblies 30 and 31. More precisely stated, sensor 190 is connected to a first input interface of control device 20 via the terminal connection points of I/O module 110 and the terminal connection points of I/O module 50. The corresponding signal lines are denoted by Arabic numeral 1. Similarly, sensor 200 is connected to another input interface of control device 20 via the terminal connection points of I/O module 130 and the terminal connection points of I/O module 80. The corresponding signal lines that are used are denoted by Arabic numeral 2. Actuator 210 is connected to an output interface of control device 20 via the terminal connection points of I/O module 140 and the terminal connection points of I/O module 90. The corresponding signal lines are denoted by Arabic numeral 3. Finally, sensor 220 is connected to an input interface of control device 20 via the terminal connection points of I/O module 160 and the terminal connection points of I/O module 100. The signal lines shown are denoted by Arabic numeral 4. I/O module 180 which is implemented as a sensor is connected to a further input interface of the control device 20 via the terminal connection points of I/O module 70. The corresponding signal lines are denoted by Arabic numeral 5.

It should be noted that each of sensors 180, 190, 200, and 220 and the actuator 210 have a respective information carrier 181, 191, 201, 221, and 211, respectively, which contains respective configuration and/or parameterization information. It should be noted, again, that each of the information carriers may be an information carrier that can be releasably attached to the housing of the respective device and which includes a QR code, for example. For example, information carriers 181, 191, 201, 211, and 221 include the address of the associated sensors 180, 190, 200, and 220, or of the associated actuator 210, and/or a resource identifier and/or a function specification of the respective sensor or actuator, as the configuration and/or parameterization information.

With the aid of the configuration and/or parameterization information stored in or on the information carriers it is possible, for example, to easily create a digital wiring protocol, for example for the automation system 10 exemplified in FIG. 1.

Assuming that a predetermined wiring list is existent, according to which the sensors 180, 190, 200, and 220 and the actuator 210 are to be connected to the control device 20.

Accordingly, the sensors, the actuator and the terminal connection points of the I/O modules are equipped with information carriers which include, as configuration and/or parameterization data, a first item of information identifying the respective I/O module, and/or a second item of information indicating a predetermined terminal connection point of the respective I/O module as a start or destination terminal connection point of a wiring, and/or a third item of information indicating a predetermined terminal connection point of a further I/O module as a destination or start terminal connection point of the respective wiring. In other words, the respective information carriers are programmed or encoded in advance in accordance with the predetermined wiring list. Subsequently, the information carriers are mounted to the corresponding terminal connection points of the I/O modules, sensors, and actuators, by an operator.

The information contents that have to be stored in the information carriers according to the wiring list shall be described with respect to the link 1 of the predetermined wiring list, by way of example. Similarly, the wiring list contains information about the information contents for the information carriers of the further links 2 to 5.

For example, the information carrier 191 of sensor 190 includes a QR code which may include the address of the sensor 190, a resource identifier, and identification information designating the destination terminal connection point to which the sensor 190 is to be connected. In the present example, sensor 190 is to be connected to destination terminal connection point 1 of I/O module 110. In addition, the information carrier 191 may also include information about the signal line 1 to be used, for example about the color, length, and cross section of the line.

For example, the information carrier 110b of I/O module 110 includes information about the fact that the sensor 190 is to be connected to terminal connection point 1 of I/O module 110. The information carrier 110a associated with the other terminal connection point 1 of I/O module 110 includes, for example, a QR code including information about the fact that the terminal connection point 1 functions as the start terminal connection point and is to be connected to destination terminal connection point 2 of I/O module 50 via a line of a predefined type 1, for example. The information carrier assigned to the destination terminal connection point 2 of I/O module 50 includes, for example, a QR code that stores information about the fact that the terminal connection point 2 is a destination terminal connection point and is to be connected to the start terminal connection point 1 of I/O module 110. Furthermore, the information carrier may contain information about the signal line to be used. The information carrier 50a assigned to the other terminal connection point 2 of the I/O module 50 may include information about the input interface of the control device 20 to which the sensor 190 is to be connected.

It should be noted that each information carrier can also store the number of the respective terminal connection point.

Once the information carriers have been encoded accordingly, they are attached at the respective locations of sensors 180, 190, 100, 220 and to actuator 210.

Subsequently, the respective information carriers are read out by the reading device 230, and the sensors and the actuator are connected to the control device 20 via signal lines 1 to 5.

Once the information of the information carriers assigned to links 1 to 5 have been read in using the reading device 230, reading device 230 creates a digital wiring protocol corresponding to the predetermined wiring list on the basis of the read-in configuration and/or parameterization information. For this purpose, the reading device 230 stores a corresponding program which can be executed by a microcontroller 232 of the reading device 230 to create the digital protocol. It is also conceivable that the information read-in and stored in the memory 231 of the reading device 230 can be transferred to a separate computer device (not shown), via interface 233, which computer device is configured to generate a digital wiring protocol for further use from the received data set representing the stored information. The digital wiring protocol can be visualized or printed out, for example. It is also conceivable that the computer device is part of an ECAD system and is configured to use the data set in order to generate a graphic image of the automation system 10.

The digital wiring protocol in particular contains information about which sensors and actuators have been wired to which terminal connection points and which signal lines have been connected between the respective terminal connection points.

A second exemplary automation system 240 shall now be discussed, which is shown in FIG. 4.

The preferably industrial automation system 240 comprises a control device 250 which may be implemented as a PLC. Assuming that the PLC 250 has a fieldbus interface 253 through which it can be connected to a fieldbus 280. Furthermore, the control device 250 comprises an NFC interface 251 and a memory 252, for example.

For the sake of simplicity of illustration, only two I/O modules 260 and 270 are connected to the fieldbus 280, with I/O module 260 being a sensor and I/O module 270 being an actuator. Sensor 260 and actuator 270 also have a fieldbus communication interface via which they are connected to the fieldbus 280. Sensor 260 includes an information carrier 261, while actuator 270 includes an information carrier 271.

Assuming this time that the information carriers do not represent attachable mechanical information carriers having a QR code applied thereon, but instead are implemented in the form of memories of NFC chips. In particular, the NFC information carrier 261 stores the address of sensor 260 and optionally a corresponding function specification of the sensor and/or a resource identifier. Similarly, the NFC information carrier 271 contains the address of the actuator and optionally a function specification of the actuator and/or a resource identifier.

For the configuration and/or parameterization of control device 250, a portable and mobile reading device 290 is used, for example, which has an NFC-capable communication interface 291. In addition, the reading device 290 may include a memory means 292 and a microprocessor 293, as shown in FIG. 3b, for example.

An operator now takes the NFC-capable reading device 290 and reads out the configuration and/or parameterization data stored in the NFC information carriers 261 and 271 in wireless manner. Subsequently, the operator moves to the control device 250, where the information stored in the reading device 290 is then written into the memory 252 of the control device 250 in wireless manner.

Control device 250 is configured to derive, from the configuration and/or parameterization data stored in memory 252, the addresses of the sensor 260 and of the actuator 270, and subsequently to transmit its own address, inter alia, to the sensor 260 and to the actuator 270, via fieldbus 280.

In this way, the control device can be quickly and easily configured and/or parameterized, by being informed about the connected I/O modules and hence about the structure of the automation system 240.

Any reconfiguration and/or re-parameterization that might be required after I/O modules have been added or replaced can thus be done very easily and error-free by simply reading out the information carriers of the replaced or newly added I/O modules and writing the read-out information into the memory 252 of control device 250. This in particular ensures that each newly added I/O module automatically receives the address of the control device 250.

1. An I/O module for use in an automation system, comprising:
at least one terminal connection point for connecting a signal line; and
at least one information carrier which contains configuration and/or parameterization information, wherein the information carrier is adapted for being read out by means of a mobile and portable reading device.

2. The I/O module of claim 1, further comprising:
a housing, wherein the information carrier can be attached on the housing of the I/O module;
wherein the configuration and/or parameterization information is applied on the information carrier in the form of an opto-electronically readable code and can be read by a mobile and portable reading device that includes an optical sensor.

3. The I/O module of claim 2, wherein the information carrier has fastening means for being releasably attached on the housing.

4. The I/O module of claim 1, wherein the information carrier is in the form of a memory of an NFC chip, and wherein the configuration and/or parameterization information stored in the information carrier can be read out by means of a mobile and portable NFC-capable reading device.

5. The I/O module of claim 1, further comprising:
a plurality of terminal connection points, each one for connecting a respective signal line, wherein each terminal connection point has an information carrier assigned thereto.

6. The I/O module of claim 1, wherein the configuration and/or parameterization information of each information carrier includes addressing information of the I/O module, and/or terminal connection point identification information, and/or a function specification, and/or a resource identifier, and/or information about a signal line to be connected to the I/O module, and/or information about a terminal connection point of a further I/O module.

7. The I/O module of claim 1, wherein the I/O module is a feed-through terminal or comprises a sensor or an actuator.

8. The I/O module of claim 1, further comprising:
fastening means for being mounted on a mounting rail; and/or
fastening means for being mounted on a component that is mounted on a mounting rail.

9. A method for configuration and/or parameterization of a control device of an automation system, which comprises at least one I/O module of claim 1, which is able to communicate with the control device via a transfer medium, the method comprising the steps of:
a) reading out the configuration and/or parameterization information from at least one information carrier of the at least one I/O module by means of a mobile and portable reading device, wherein the configuration and/or parameterization information read out from the at least one information carrier contains addressing information of the I/O module;
b) reading into a memory of the control device the configuration and/or parameterization information stored in the reading device; and
c) transmitting addressing information from the control device to the at least one I/O module.

10. The method of claim 9, wherein in step a), the configuration and/or parameterization information is read out from the at least one information carrier of the at least one I/O module in wireless manner; and in step b), the configuration and/or parameterization information stored in the reading device is read into the memory of the control device in wireless manner.

11. A method of creating a digital wiring protocol for an automation system that comprises a plurality of I/O modules of claim 1, which are connected to a control device via a transfer medium, the method comprising:
a) assigning a respective information carrier to predetermined terminal connection points of the I/O modules included in the automation system using a predetermined wiring list, which information carrier contains, as configuration and/or parameterization information, a first item of information identifying the respective I/O module, and/or a second item of information indicating a predetermined terminal connection point of the respective I/O module as a start or destination terminal connection point of a wiring, and/or a third item of information indicating a predetermined terminal connection point of a further I/O module as a destination or start terminal connection point of the respective wiring;
b) reading out the configuration and/or parameterization information from the information carriers which have been assigned to the predetermined terminal connection points in step a), by means of a mobile and portable reading device; and
c) creating a digital wiring protocol for further use from the read configuration and/or parameterization information in the reading device or in a separate computer device.
